(19) United States
(12) Patent Application Publication
(10) Pub. No.: US 2003/0019816 A1
(43) Pub. Date: Jan. 30, 2003

(54) Apparatus and a method for treating a sample by planar separation using controlled pressurized flow

(76) Inventors: Emil Mincsovics, Szentendre (HU); Laszlo Kecskes, Budapest (HU); Erno Tyihak, Budapest (HU); Barnabas Tapa, Budapest (HU)

Correspondence Address: Lawrence E. Laubscher, Sr., EFS Customer No. 30267311, Suite 300, 745 South 23rd Street, Arlington, VA, 22202-2451, US

(21) Appl. No.: 10/188,044

(22) Filed: Jul. 3, 2002

Related U.S. Application Data
(63) Continuation of application No. PCT/FR01/00022, filed on Jan. 3, 2001.

(30) Foreign Application Priority Data
Jan. 4, 2000 (FR) 00/00063

(51) Int. Cl. C02F 1/00

(52) U.S. Cl. 210/741; 210/767; 210/808; 210/97; 210/143; 436/174; 422/63; 422/99

(57) ABSTRACT

Apparatus for treating a sample by pressurized planar separation comprises a chamber (1) housing a stationary phase (2) provided at a first location (6) with a sample to be treated, pressurization means (8) for pressurizing a top face (5) of the stationary phase, dispenser means (10) for dispensing a moving phase at a second location (7) of the stationary phase, a feed inlet (13) for feeding the moving phase, and a removal outlet (18) for removing the moving phase from the chamber. The apparatus also comprises feed means (23) for feeding the inlet (13) with moving phase, a sensor (29) for measuring the pressure of the moving phase upstream from the inlet, a valve (31) placed downstream from the outlet to vary the flow rate of the moving phase leaving the chamber, and a module (25) for controlling the valve as a function of a comparison between the measured pressure and a selected threshold pressure, the valve (31) being opened when the measured pressure becomes greater than or equal to the threshold pressure.

The invention relates to the field of separating the components of a “complex” sample in planar manner with the help of a pressurized flow.

Pressurized planar separation (well known as OPLC for Over Pressured Layer Chromatography or Optimum Performance Layer Chromatography) is a technique for separating the components of a sample, the sample being placed in at least one selected first location on a thin layer which is referred to as the “stationary phase”, and its components are separated by means of a carrier fluid which is referred to as the “moving phase”, which carrier fluid is under pressure. Entrained by the moving phase, the components migrate on the stationary phase in a known order that is a function of their retention.

For this purpose, certain treatment apparatuses comprise a separation chamber into which at least one stationary phase is introduced. The chamber has pressurization means enabling a pressure of selected magnitude to be applied to a top face of the stationary phase, dispenser means enabling at least one moving phase to be delivered to at least one selected second location of the stationary phase, at least one inlet for feeding said dispenser means, and at least one outlet enabling the moving phase to be removed.

The moving phase which is introduced into the separation chamber of that type of apparatus moves over the stationary phase with a front known as an “alpha front”. Under the effect of the applied pressure, the alpha front expels the air trapped in the initially dry stationary phase. However, some air remains trapped in an “alpha” zone that is situated immediately behind the alpha front and that precedes a zone which is completely wetted and which is referred to as the “zone of total wetness”. As a result, the total wetness front and the alpha front are not linear, and that is detrimental to separation effectiveness, to the reproducibility of results, and to the precision of analyses performed simultaneously or consecutively.

No known solution enables the linearity of the fronts to be controlled sufficiently accurately, and in particular the linearity of the total wetness front.

An object of the invention is therefore to improve the situation.

To this end, the invention provides apparatus of the type described in the introduction, in which regulation means are provided enabling the pressure of the moving phase upstream and/or downstream of the stationary phase to be controlled so that this pressure remains lower than or equal to a threshold pressure, which is a function of the selected external pressure.

In the following, “moving phase” means any fluid permitting to displace the constituents of a sample on the stationary phase. This fluid may be a liquid or a gas such as air permitting to push a solvent previously introduced in the separating chamber.

These regulation means preferably comprise at least one valve placed downstream from the first moving phase outlet and organized to vary the flow rate of the moving phase leaving the chamber at least between a zero value and a maximum value.

More preferably still, the regulation means comprise means enabling the pressure of the moving phase to be measured upstream from the first inlet and/or downstream from the first outlet, together with a module organized to control the valve as a function of a comparison between the measured pressure and the threshold pressure function of the selected external pressure (or more briefly the threshold pressure), the valve being opened to allow the moving phase to leave when the measured pressure is greater than or equal to the threshold pressure.

As a result, the air which is initially trapped in the stationary phase is compressed progressively ahead of the alpha front until the measured pressure reaches the selected threshold value. Pressure thus increases progressively throughout the moving phase, including in the alpha zone, so the speed of migration of the moving phase and the width of the alpha zone decrease, thus giving rise to the total wetness front being quasi-linear.

Two modes of operation can advantageously be envisaged for the apparatus of the invention. In an “off-line” or “infusion” first mode, the stationary phase is extracted from the chamber after the components of the sample have been separated, and is then placed in an external analyzer in order to identify and/or quantify the components, e.g. by densitometry or video scanning or indeed radiometric scanning.

In this mode, where the sample is preferably placed on the stationary phase before the moving phase is fed thereto, the control module controls simultaneously the valve, the feed means, and the pressurization means so that the moving phase is fed throughout the entire duration of separation by keeping the valve closed, i.e. until the measured pressure of the moving phase reaches the threshold pressure. Thereafter moving phase feed is interrupted and the valve is opened and the external pressure is released.

In a “on-line” or “infusion/transfusion” second mode, the components as separated on the stationary phase are identified and/or quantified with the help of analyzers on this stationary phase and/or on-line at the output of the chamber. The analysis can be performed, for example, by chromatography, electrophoresis, ultraviolet (UV) or visible detection, or mass spectrometry. With on-line analysis, the separated components are incorporated in the moving phase that leaves the chamber.

In this mode, the control module also simultaneously controls the valve, the feed means, and the pressurization means in such a manner that the moving phase is fed throughout the entire duration of separation and of analysis by keeping the valve closed so long as the measured pressure of the moving phase is less than the threshold pressure, after which the valve is kept open.

In this case, the sample can be placed on the stationary phase either before the moving phase begins to be fed, or else once the valve has been placed in the open position.

The apparatus of the invention can have further additional characteristics, taken separately or in combination, and in particular:

the chamber can be organized in such a manner as to receive an extractable cassette including the stationary phase;

the pressurization means can comprise a flexible film housed in register with the top face of the stationary film and application means suitable for pressing the film against the stationary phase so as to apply the pressure of selected magnitude thereto;

the application means can comprise a tank of fluid for generating the external pressure (or more briefly an external pressurization fluid), the tank being coupled to a feed circuit; however other means can be envisaged, such as pneumatic means or mechanical means;

the tank of pressurization fluid and the moving phase feed means can be housed in a common fluid feed unit;

the stationary phase can be provided with the sample to be treated prior to being introduced into the chamber, or it can be provided with said sample after it has been introduced into the chamber, using the same inlet or indeed via another inlet; and

the control module can be organized in such a manner that prior to delivery of the sample it firstly causes the valve to take up a state that prevents the moving phase from being removed, and secondly it causes the feed means to deliver a selected volume of the moving phase to the stationary phase, the volume preferably being selected in such a manner that it corresponds to the moving phase having a measured pressure substantially equal to the threshold pressure.

The invention also provides a method of treating the components of at least one sample by pressurized planar separation. The method comprises the following steps:

a) placing at least one stationary phase in a chamber, the stationary phase being suitable for receiving at least one sample for treatment at at least one selected first location;

b) feeding at least one second selected location of the stationary phase with moving phase while applying pressure of selected magnitude to the top face of the stationary phase and preventing the moving phase to leave the stationary phase;

c) measuring the pressure of the moving phase upstream and/or downstream from the chamber; and

d) comparing each measured pressure with a threshold pressure depending on the selected external pressure and, when the measured pressure is greater than or equal to the threshold pressure, reducing the pressure of the moving phase so that it remains lower than or equal to this threshold pressure.

Other characteristics and advantages of the invention appear on examining the following detailed description and the accompanying drawings, in which:

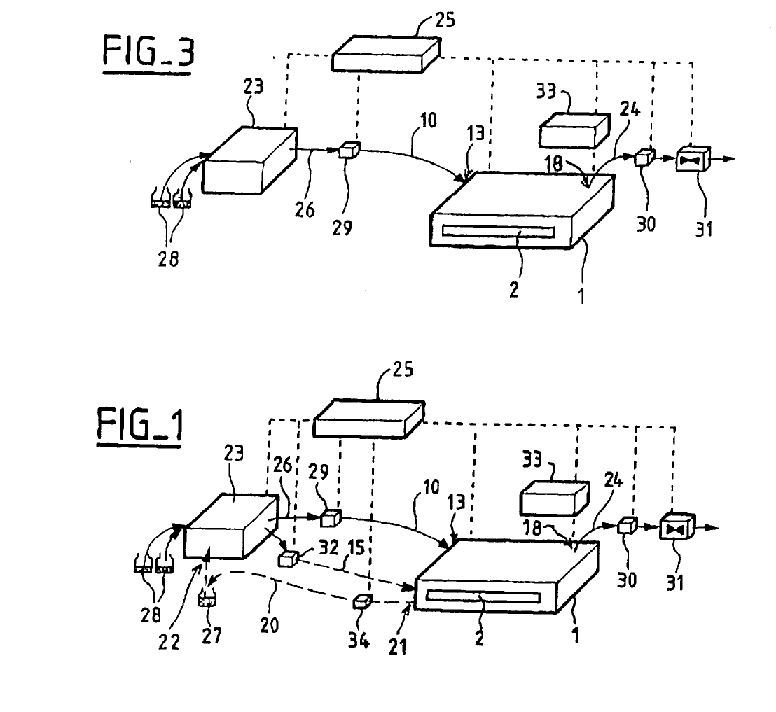

FIG. 1 is a diagram showing an embodiment of apparatus of the invention suitable for separation in infusion mode and/or in infusion/transfusion mode;

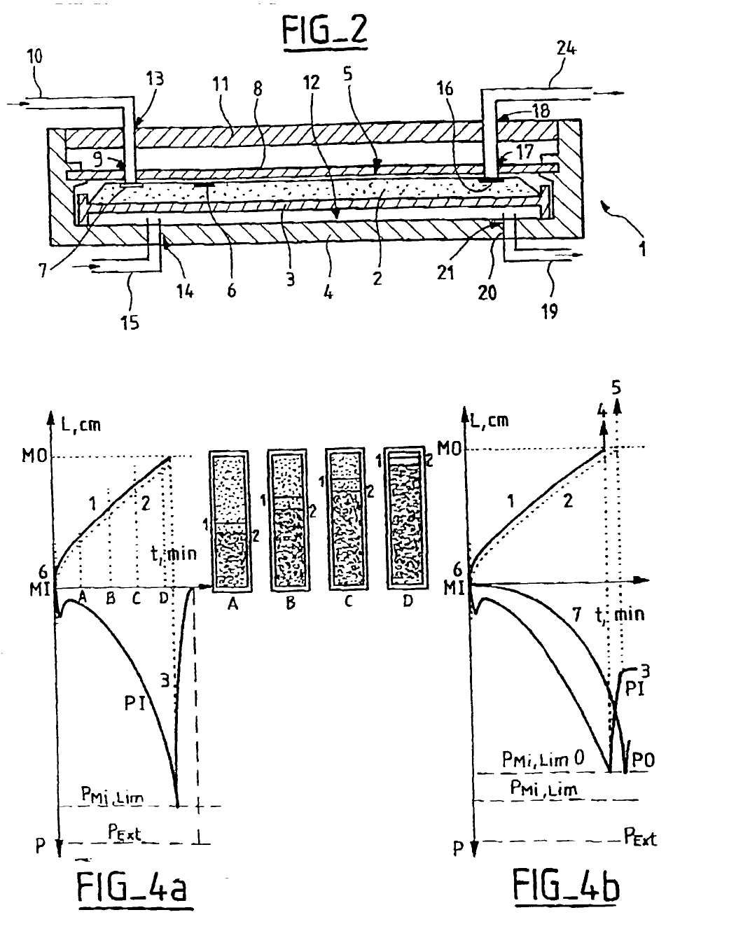

FIG. 2 is a cross-section through the separation chamber of FIG. 1;

FIG. 3 shows a variant of FIG. 1 in which the pressurization means are not hydraulic, but are mechanical, for example;

FIGS. 4a and 4b are graphs comparing variations as a function of time in the alpha and total wetness fronts and in the measured pressure for the infusion mode (a) and for the infusion/transfusion mode (b) in the case of a regulation of the pressure of the moving phase measured upstream of the chamber, and

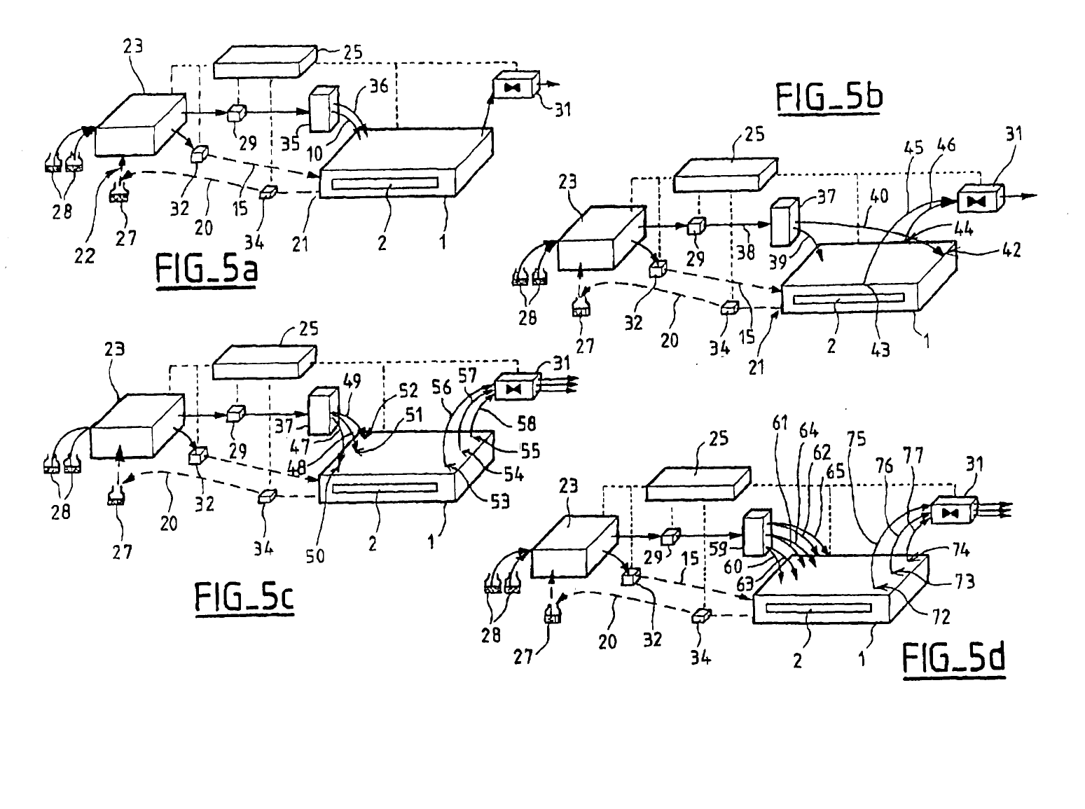

FIGS. 5a to 5d show variants of the apparatus of FIGS. 1 and 3.

For the most part, the drawings are definitive in nature. Consequently they can serve not only to complement the description, but they can also contribute to defining the invention, where appropriate.

In the following detailed description, reference is made to apparatus for treating a complex sample by planar separation using controlled pressurized flow (or OPLC). The term “treatment” is used herein with respect to a sample mainly to cover separating the components making up the sample, optionally coupled with one or more on-line or off-line analyses of the separated components.

The apparatus shown in FIGS. 1 and 2 comprises firstly a separation chamber 1 adapted to receive a thin layer or sorbent layer 2 forming a stationary phase. By way of example, the thin layer 2 can be constituted by silicate gel, alumina, magnesium silicate, talc based on inorganic components, cellulose, powdered synthetic resin, polyamides based on organic components, or indeed derivatives or mixtures of some of these components. However, it is clear that the material used and its surface state (granularity, porosity, and the like) depend on the type of sample that is to treated.

The thin layer 2 preferably rests on a rigid support 3 itself supported by the bottom of the bottom portion 4 of the chamber 1, and at a distance therefrom so that a cavity 12 is formed beneath the support 3. The sample(s) to be treated is/are placed at at least one first selected location 6 on the top face 5 of the thin layer 2, remote from the bottom 4. The moving phase is introduced onto the same top face 5, at at least one second selected location 7. As mentioned above, the moving phase is designed to cause the components of the sample to migrate.

The term “location” is used herein to cover both a localized spot and an extended strip of the type comprising a line that can be straight, or curvilinear, or circular, or indeed of any other selected shape.

As explained below, the first and second locations 6 and 7 can coincide, at least in part. The person skilled in the art knows how to select the first or second locations as a function of the type of treatment that is to be performed. Thus, depending on the respective positions of the first and second location(s) 6 and 7, separation can be unidirectional or bidirectional or circular or indeed anticircular. However that is well known to the person skilled in the art and does not constitute the subject matter of the present invention.

At a small distance above the top face 5 of the thin layer 2 there is placed an impermeable flexible film 8, e.g. made of Teflon. As explained below, the film 8 is designed to apply pressure, whether uniform or otherwise, on the top face 5 of the stationary phase 2. In the example shown in FIG. 2, the film 8 comprises, in register with at least a portion of the second location 7, a first opening 8 to pass in leakproof manner the end of a tube 10 designed to dispense the moving phase at the second location 7.

In a variant, the thin layer 2 (or stationary phase) can initially be housed in a cassette organized to be introduced into the chamber prior to treatment. The top wall of the cassette can optionally comprise a flexible pressurization film. In this variant, it is preferable for the sample to be implanted in the stationary phase 2 before the cassette is introduced into the chamber 1. However that is not essential, particularly when the cassette does not have a flexible film.

If the sample needs to be introduced onto the thin film 2 (or stationary phase) after it has been placed in the chamber 1, the film 8 has, in register with at least a portion of the first location 6, a second opening for passing in leakproof manner the end of tube for introducing the sample to the first location 6. Naturally, when the first and second locations 6 and 7 coincide, at least in part, a single opening can suffice for introducing both the moving phase and the sample.

The top portion of the chamber 1 is closed by a wall 11 placed, in the example shown in FIGS. 1 and 2, slightly above the film 8. This top wall 11 has a first inlet 13 for passing in leakproof manner the end of the tube 10 for dispensing the moving phase. The bottom wall 4 of the chamber has a second inlet 14 for passing in leakproof manner the end of a tube 15 for feeding the pressurization fluid. The external pressurization fluid can be a gas, or it can be a liquid such as water as in the example described below.

The external pressurization fluid preferably circulates around a closed circuit, with the upstream feed portion thereof being constituted by the tube 10 and with the downstream thereof being constituted by a tube 19 having a first end 20 opening out into the cavity 12 of the chamber 1 via a leakproof opening 21 formed through its bottom wall 4, for example, and having the opposite end 22 of said tube 19 opening out into a tank 27 of external pressurization fluid. The tank 27 is coupled to a first micropump which is controlled by the control module 25 of the apparatus and which is preferably housed in a fluid feed unit 23.

Also preferably, the pressurization fluid feed tube 15 is provided with a pressure sensor 32 which delivers its pressure measurement to the control module 25. The control module 25 can thus act on the first micropump for fixing the rate at which pressurization fluid is fed depending on requirements, and consequently fixing the external pressure which is applied to the thin layer 2. A valve 34 can also be provided on the tube 20 between the opening 21 and the tank 27.

When the pressurization fluid flows, it exerts substantially vertical external pressure on the bottom race of the support 3, thereby raising it and consequently pressing the film 8 and the stationary phase 2 against each other with pressure of selected magnitude.

As shown in the example of FIG. 3, other means can be envisaged for external pressurization of the stationary phase 2, e.g. means that are mechanical, or pneumatic, or the like. In some cases, this can make it possible to avoid using an external circuit for feeding pressurization fluid.

In the example shown in FIGS. 1 and 2, the chamber includes, at at least one selected third location 16 that can be localized or extended, a collection zone for collecting the moving phase that has been used for separating the components of the sample. This third location can be situated on the stationary phase 2, as illustrated in FIG. 2, or at the periphery thereof. In the first case, the film 8 has a second opening 17 for passing in leakproof manner the end of a tube 24 for collecting the moving phase. The chamber 1 has a leakproof outlet 18 through which this end of the tube 24 passes. In the second case, such a second opening is not necessary, only the outlet 18 is required.

The tube 10 which supplies the moving phase to the thin layer 2 has an end 26 connected to a second micropump coupled to one or more tanks of moving phase 28 for a continuous stepwise variation and likewise controlled by the control module 25. The second micropump is preferably also housed in the unit 23.

Naturally, in the example of FIG. 3, the fluid feed unit 23 serves to feed only the moving phase, and consequently it has only one micropump.

In accordance with the invention, a pressure sensor 29 is provided upstream from the moving phase inlet 13 of the chamber 1, or a pressure sensor 30 is provided downstream from the moving face outlet 18 of the chamber 1.

However, as shown in FIGS. 1 and 3, it is also possible to provide a first pressure sensor 29 upstream from the moving phase inlet 13 of the chamber 1 and a second pressure sensor 30 downstream from the moving phase outlet 18 of the chamber 2. This solution using two sensors is particularly advantageous since it makes it possible to improve the accuracy with which the apparatus is controlled. The first sensor 29 is organized so as to perform its pressure measurement on the moving phase flowing in the feed tube 10, while the second sensor 30 is organized so as to perform its pressure measurement on the moving phase flowing in the collection tube 24. The first sensor 29 thus delivers an upstream pressure measurement PI to the control module 25 while the second sensor 30 delivers a downstream pressure measurement PO to said control module 25.

The invention also provides a valve 31 organized to control the flow rate of the moving phase downstream from the moving phase outlet 18. This valve is thus installed on the collection tube 24, preferably downstream from the second pressure sensor 30 (when one is provided).

The operative state of the valve 31 is controlled by the control module 25 as a function of a first comparison between the first pressure PI as measured by the first sensor 29 and a first threshold pressure PMI, Lim, and a second comparison between the second pressure PO as measured by the second sensor 30 and a second threshold pressure PMO, Lim. PMI,Lim and/or PMO, Lim are selected to be lower than the applied external pressure P_{Ext}.

The first and second threshold pressures PMI, Lim and PMO, Lim and P_{Ext} are stored in registers of a memory, preferably a read/write memory, so as to enable the threshold values to be adapted to conditions of use for infusion of infusion-transfusion. The external pressure is released after the separation.

Naturally, when only one pressure sensor (29 or 30) is provided, the operative state of the valve 31 is controlled by the control module 25 as a function of a single comparison between the measured pressure (PI or PO) and the associated threshold pressure (PMI, Lim or PMO, Lim).

The flow rate of the moving phase fed to the chamber 1 and the pressure applied to the thin layer 2 are preferably also controlled by the control module 25 via the feed micropumps.

Thus, by acting simultaneously on the pressurization means (flow rate of the pressurization fluid or force applied to the stationary phase 2) and on the valve 31 (and thus on the rate at which the moving phase is collected) and on the moving phase feed rate, it is possible to control very accurately the linearity of the total wetness front which characterizes the displacement of the moving phase in the stationary phase 2 under drive from the pressurization means.

As mentioned above, when the valve 31 is placed in a “closed” state (zero flow rate) in which it prevents the moving phase from being removed from the chamber 1, the air “trapped” in the stationary phase, prior to the arrival of the moving phase, is compressed progressively ahead of the alpha front. The pressure of this alpha front therefore increases progressively while its speed of migration decreases progressively. The width of the partially wetted zone (or alpha zone) situated between the alpha front and the total wetness front, therefore diminishes progressively, so the total wetness front tends progressively towards being quasi-linear.

This state of quasi-linearity corresponds to threshold pressures (PMI, Lim and PMO, Lim) of the moving phase upstream and downstream from the chamber 1 which can easily be determined.

The control module 25 therefore need only perform comparisons to monitor whether or not the measured pressures are respectively greater than or less than the associated threshold pressures. When the measured pressures PI and PO are greater than or equal to the threshold pressures PMI, Lim and PMO, Lim which are lower than P_{Ext}, the control module 25 acts on the valve 31, and possibly on at least one of the feed micropumps, so that the moving phase leaves the chamber 1. When the valve 31 is a variable flow rate valve (as contrasted with a valve that operates in binary or “on/off” manner), then the authorized collection (or removal) flow rate is determined as a function of the difference between the measured pressure and the associated threshold pressure during the time period where the partially wetted zone leaves the stationary phase 2 and the chamber 1.

In contrast, with on/off type operation, which is presently preferred for reasons of simplicity of regulation, the valve 31 is switched from the “closed” state to the “open” state or vice versa depending on the result of the comparisons. The “closed” state corresponds to a flow rate having the value zero, while the “open” state corresponds to the flow rate having a maximum value.

Two modes of operation can be envisaged. The first mode corresponds to the apparatus operating in an “off-line” or “infusion” type manner, in which the treatment within the apparatus consists in no more than separating the components of sample. Analysis (determination and/or quantification) of the components is then performed in an external analyzer after the components have been separated and the stationary phase 2 has been extracted. Any type of analysis known to the person skilled in the art can be envisaged.

In this first mode where the sample can be put into place before or after the stationary phase 2 is inserted in the chamber 1, it is preferable to start with a stationary phase that is “dry”, i.e. prior to being fed with the moving phase. The control module 25 causes the valve 31 to be closed completely and then it causes the moving phase to be fed in. The valve 31 is kept closed throughout the entire duration of separation, i.e. so long as the measured pressure PI of the moving phase upstream from the chamber remains less than the threshold pressure PMI, Lim or, as disclosed herebelow in FIG. 4b, than PMI, Lim0.

Thereafter, once the threshold PMI, Lim has been reached or exceeded, the moving phase feed is interrupted by acting on the corresponding micropump and the valve 31 is opened, so that the pressure of the moving phase is reduced, for example to the ambient pressure and then the external pressure is released. Naturally, as mentioned above, when the valve 31 operates in on/off mode, it is switched from the closed state to the open state. In contrast, when the valve 31 is a variable flow rate valve, it is switched from the closed state to one of its open states that authorizes the moving phase to be removed from the chamber at a flow rate that is not zero (i.e. greater than zero and less than or equal to the maximum flow rate). This state is selected by the control module as a function of a criterion which is itself a function of the separation conditions. It is based on the difference of viscosity between air and the moving phase.

The second mode corresponds to the apparatus operating in a manner of the “on-line” or “infusion/transfusion” type. The treatment in the apparatus consists in separating the components of the sample coupled with on-line analysis of said components and/or with external analysis. The separated components are thus identified and/or quantified on the stationary phase 2 and/or outside the chamber by analyzing the moving phase that leaves the chamber and that includes the separated components.

In this second mode, it is possible to introduce the sample onto the stationary phase 2 prior to infusion, i.e. before the moving phase has been introduced. However that is not necessarily the case, and it is also possible for an infusion step to precede introduction of the sample. The volume used for infusion by the control module is known when this latter knows the type of the used stationary phase.

The components of the sample are separated under the combined action of permanent moving phase feed and control of the state of the valve 31. As in infusion mode, the control module 25 begins by causing the valve 31 to be closed completely and then causes the moving phase to be fed in In an embodiment including only one upstream pressure sensor, the valve 31 is kept closed so long as the measured pressure PI of the moving phase upstream from the chamber remains less than the threshold pressure PMI, Lim0, as disclosed herebelow in FIG. 4b, than PMI,Lim0.

However, when the threshold PMI, Lim (or PMI, Lim0) is reached or exceeded, moving phase feed is maintained and the valve 31 is opened. Naturally, as mentioned above, when the valve 31 operates in on/off mode, it is switched from the closed state to the open state, thereby authorizing the moving phase to be removed from the chamber at a maximum flow rate. In contrast, when the valve 31 is a variable flow rate valve, it is switched from the closed state to one of its open states, thereby authorizing the moving phase to be removed from the chamber at a flow rate that is not zero (greater than zero and less than or equal to the maximum flow rate). This state is selected by the control module as a function of a criterion which is itself a function of the separation conditions. Once separation has been terminated, the components are analyzed in the stationary phase and/or externally by using the moving phase leaving the chamber together with the separated components of the sample.

As shown in FIGS. 1 and 3, it is possible to provide a module 33 for supplying current or voltage to electrodes that are housed inside the chamber 1 in order to perform separation by electrochromatography or electrophoresis. These electrodes are placed parallel or perpendicular to the flow, with electrophoresis being performed either simultaneously or sequentially relative to separation by means of the moving phase.

However, electrochromatography may be performed after a pre-wetting infusion in the open state of valve 31, by means of electrodes perpendicular to the flux. After pre-wetting, electrochromatography and chromatography may be performed simultaneously or sequentially. The chromatographic and electrophorectic separation may be performed on the pre-wetted stationary phase by means of electrodes parallel or perpendicular to the flux. The electrophoresis is of course performed in a wetted phase.

The stationary phase can also have a plurality of zones that are identical or different, each enabling a particular kind of treatment to be performed (separation and/or analysis). The pressurization means used in the various zones can optionally be different, or else they can be identical but provide different pressures.

These various cases are illustrated by the graphs of FIGS. 4a (infusion) and 4b (infusion/transfusion). More precisely, the top portions of these graphs compare variation over time in the positions of the alpha front (continuous line referenced 1) and of the total wetness front (dashed line referenced 2), while the bottom portions thereof show variation over time in the pressure PI measured upstream from the inlet of the chamber 13 (continuous line referenced 3) and the pressure PO measured downstream from the outlet 18 of the chamber 13 (continuous line referenced 7).

The rectangles referenced A, B, C, and D show instantaneous profiles of the alpha front (1) and of the total wetness front (2) at four successive instants.

In the top portions of the graphs, MI designates the location at which the moving phase is introduced (i.e. the second selected location 7), while MO designates the location at which the moving phase is collected (i.e. the third selected location 16). Reference (6) designates the location at which the sample is implanted between MI and MO. Reference (4) designates the location and the instant at which the alpha front (1) disappears. Reference (5) designates the location and the instant at which the total wetness front (2) disappears.

Furthermore:

P_{MI, LIM} designates the threshold pressure (previously referenced PSI) upstream from the inlet 13 of the chamber:

PO designates the pressure measured downstream from the outlet 18 of the chamber;

P_{Ext} designates the pressure applied to the stationary phase by the pressurization means (P_{Ext} is always greater than the measured pressures of the moving phase, and P_{MI,Lim} (or PSI) is selected to be substantially equal to about 80% of P_{Ext}); and

P_{MI, Lim O} designates the threshold pressure (previously designated by PSO) downstream from the outlet 18 of the chamber 1. In FIG. 4b (infusion/transfusion), this pressure (PSO) is selected to be less than the threshold pressure PSI. It corresponds to the instant at which the valve 31 should be opened, while maintaining moving phase feed. When the device operates according to this mode, the control module calculates PMI,Lim0 directly from P_{Ext}.

Reference is now made to FIGS. 5a to 5d to describe variants of the apparatuses shown in FIG. 1 and 3. In these variants, all elements that are substantially identical to those of FIGS. 1 and 3 are given identical references. Naturally, these variants constitute only a few possibilities amongst many others.

FIG. 5a shows a first variant in which a unit 35 is provided enabling the stationary phase to be fed both with the moving phase and with the sample. This unit 35 is thus placed on the fluid feed tube 10 between the upstream pressure sensor 28 and the inlet 13 of the chamber 1, and it is connected to a tube 36 for injecting the sample, which tube penetrates into the chamber via an inlet provided for this purpose and opening out in register with the first location 6. A single tube 10 could be provided for injecting both the moving phase and the sample.

FIG. 5b shows a second variant in which a unit 37 is provided for feeding the stationary phase at two different and independent second locations in order to perform separation of bidirectional type, or else to perform two separations of samples placed on two different stationary phases. A tube 38 feeds the unit 37 with moving phase, while two tubes 39 and 40 leave the unit 37 each for the purpose of feeding a respective one of the two second locations, after penetrating into the chamber via two inlets 41 and 42 and passing through the film 8 via two leakproof openings 9 and 17 provided in register with the two second locations. In the bidirectional case, a substantially linear line of moving phase is established between the two injection locations and separation takes place substantially perpendicularly to said line. The unit 37 also has the function of directing the moving phase(s) to appropriate zones of the stationary phase(s).

In this variant, two independent third locations are provided to collect each of the moving phases that have been used for separating the components of the sample(s) in each of the two portions of the chamber 1. The chamber thus has two independent collection outlets 43 and 44 feeding two tubes 4S and 46 connected to the valve 31 which consequently has two inlets and one outlet.

FIG. 5c shows a third variant in which a unit 37 is provided for feeding the stationary phase in parallel at three different and independent second locations, possibly formed on three different stationary phases. A tube 38 feeds the unit 37 with moving phase, and three tubes 47, 48, and 49 go from the unit 37 to feed each of three respective second locations after penetrating into the chamber via three inlets 50, 51, and 52 and passing through the film 8 via three leakproof openings 9 provided in register with the three second locations.

In this variant using unidirectional type separation, three independent third locations are provided to collect each of the moving phases that have been used for separating the components of the sample(s) in each of the three portions of the chamber 1. This chamber therefore has three independent collection outlets 53, 54, and 55 feeding three tubes 56, 57, and 58 connected to the valve 31 which in this variant is a triple valve enabling each of the three collected moving phases to be delivered separately and independently.

FIG. 5d shows a fourth variant in which a unit 59 is provided for feeding the stationary phase both with moving phase and with sample. The moving phase can be fed in parallel on three paths, as in FIG. 5c, and similarly the sample can be implanted in parallel on three paths. The unit 59 is thus connected firstly to three moving phase feed tubes 60, 61, and 62 which penetrate into the chamber via three fluid inlets 66, 67, and 68 and which pass through the film 8 via three leakproof openings 9 provided in register with three second locations, and secondly with three sample injection tubes 63, 64, and 65 which penetrate into the chamber via three sample inlets 69, 70, and 71 and which pass through the film 8 via three leakproof openings provided in register with three first locations.

In this variant that performs separation of unidirectional type, three independent third locations are provided to collect each of the moving phases that have been used for separating the components of the sample(s) in each of the three portions of the chamber 1. The chamber thus has three independent collection outlets 72, 73, and 74 feeding three tubes 75, 76, and 77 connected to the valve 31, which in this variant is a triple valve enabling each of the three collected moving phases to be delivered separately and independently.

The invention also provides a method of treating a sample by pressurized planar separation (OPLC). The method comprises the following steps.

In a first step, at least one stationary phase suitable for receiving at least one sample to be treated at at least one selected first location is placed in a chamber. Naturally, the chamber can be organized to receive a plurality of stationary phases in parallel or in series, or indeed stacked on one another, as is well known to the person skilled in the art.

This stationary phase, which is preferably a thin layer of the type described in the description of the apparatus of the invention, is either placed directly in the chamber on a support provided for this purpose, or else is initially placed in a cassette which is subsequently introduced into the chamber. Similarly, the sample can be placed on the stationary phase provided for separating its components prior to the stationary phase being introduced into the chamber, or else it can be implanted (or injected) after the stationary phase has been introduced into the chamber.

In a second step, at least one selected second location of the stationary phase is fed with moving phase while simultaneously applying pressure of selected magnitude on a top face of the stationary phase and preventing the moving phase to leave the stationary phase.

This pressure is not necessarily uniform. It can be envisaged to apply pressures that are different in different zones of a single stationary phase, or in different stationary phases placed in the same chamber

In a third step, the pressure of the moving phase is measured upstream and/or downstream from the chamber

In a fourth step, the upstream and/or downstream pressure(s) as measured is/are compared with respective upstream and/or downstream threshold pressure(s). Then, once the measured pressure(s) is/are greater than or equal to the associated threshold pressure(s), the moving phase is allowed to leave the chamber at a non-zero flow rate. In an on/off type of operating mode, the flow rate cannot be adapted (the moving phase is at ambient pressure). However, in a “variable” type operating mode, the magnitude of the flow rate can be selected as a function of the result of the comparison.

As described above in the portion describing the apparatus, the method can be applied to infusion (or “off-line”) mode, or else to infusion/transfusion (or “on-line”) mode.

The separation by usual transfusion is also possible when the valve 31 is in its open state during the separation process.

In infusion mode, during the fourth step of the method, the moving phase feed to the stationary phase is definitively interrupted when the measured upstream pressure becomes greater than or equal to the associated threshold pressure PMI, Lim. As shown in FIG. 4b, it is possible to use PMI, Lim0 as a threshold pressure in the comparison, said pressure being lower than PMI, Lim. Then the moving phase is placed at the ambient pressure, preferably, so that the pressure of the moving phase is reduced and finally, the external pressure is released.

In infusion/transfusion mode, during the fourth step, the moving phase is prevented from leaving the chamber, and then moving phase is fed in. The moving phase continues to be prevented from leaving so long as the measured pressure of the moving phase upstream from the chamber remains less than the threshold pressure. When the threshold PMI, Lim or PMI, Lim0 (according to the initial selection) is reached or exceeded, moving phase feed is maintained while moving phase is allowed to leave the chamber. It can be envisaged that once the valve has been opened, the rate at which the moving phase flows out is regulated so that the measured pressure(s) of said moving phase remain(s) substantially between the associated threshold pressure(s) and a corresponding minimum pressure, throughout the entire duration of the treatment.

In a preferred embodiment, during the second step, pressure is applied to the stationary phase by means that are hydraulic, preferably using a liquid. However other modes of application can be envisaged, in particular by means that are mechanical or pneumatic.

During the first step, it is possible to begin by feeding moving phase to the stationary phase prior to implanting the sample. This feed consists in filling the stationary phase with a selected volume. Removal of the moving phase from the chamber is consequently prevented during this feed stage. Advantageously, the volume of the moving phase which is admitted into the chamber corresponds more or less to the total volume of the stationary phase when the measured pressure is substantially equal to the threshold pressure.

More generally, everything said in the portion describing the apparatus applies equally to the method.

The invention is not limited to the embodiments of apparatuses and the implementations of methods as described above purely by way of example, but covers all variants that the person skilled in the art can envisage within the ambit of the following claims.

Thus, apparatuses are described in which the flow regulation means advantageously comprise a control module coupled to a valve and to means for measuring the pressure of the moving phase upstream and/or downstream of the chamber. However, the invention also applies to apparatuses in which the flow regulation means comprise only a valve for regulating the flow rate of the moving phase within the chamber, said valve being controlled either manually or else by a programmable control module.

In addition, the apparatuses described have a chamber that treats only one or more stationary phases that are placed side by side on a common support. However the chamber can be adapted to receive a plurality of stationary phases that are stacked one on another, with or without supports, and that are used in series or in parallel, with or without spacers.

On the other hand, the disclosed embodiment includes the introduction of a liquid moving phase for moving the constituents of the sample. The invention applies also when a solvent is first introduced, then a gas such as air is used for pushing the mixture of solvent and of the constituents of the solvent. The air forms the moving phase. This technique is known as a “flash” chromatography. It results therefrom that the moving phase according to the invention is a moving fluid, either gaseous or liquid.

1. Apparatus for treating a sample by pressurized planar separation, the apparatus being of the type comprising:
a chamber (1) organized to house at least one stationary phase (2) suitable for receiving at at least one selected first location (6) at least one sample to be treated, pressurization means (8) suitable for applying an external pressure of selected magnitude on a top face of the stationary phase, dispenser means (10) for dispensing a moving phase at at least one selected second location (7) of the stationary phase (2), at least one first inlet (13) for feeding said dispenser means (10) with the moving phase, and a first outlet (18) for removing the moving phase from the chamber (1); and
feed means organized to feed said first inlet (13) with moving phase;
the apparatus being characterized in that it comprises regulation means (25, 29, 30, 31) suitable for controlling the pressure of the moving phase upstream and/or downstream of the stationary phase (2) so that this pressure remains lower than or equal to a threshold pressure which depends on the selected external pressure.

2. Apparatus according to claim 1, characterized in that said regulation means comprise a valve (31) placed downstream from said first outlet (18) and suitable for causing the flow rate of the moving phase leaving the chamber (1) to vary at least between a zero value and a maximum value.

3. Apparatus according to claim 2, characterized in that said regulation means comprise means (29; 30) suitable for measuring the pressure of the moving phase upstream from said first inlet (13) and/or downstream from said first outlet (18), and a module (25) organized to control said valve (31) as a function of a comparison between the measured pressure and the threshold pressure, said valve being placed in an open state when the measured pressure is larger than or equal to the threshold pressure.

4. Apparatus according to claim 3, characterized in that said control module (25) is organized to control said feed means and said pressurization means (8) together with said valve (31) as a function of said comparison.

5. Apparatus according to claim 4, characterized in that said control module (25) is suitable for causing said feed means to interrupt the feeding of the chamber (1) with moving phase, and for causing said valve (31) to take up an open state and the external pressurization means to release the external pressure as soon as the measured pressure becomes greater than or equal to the threshold pressure.

6. Apparatus according to claim 4, characterized in that said control module (25) is organized, after the valve has been opened, to cause said feed means (23) to continue to feed the first inlet (13) of said chamber with the moving phase, and to cause the valve (31) to put itself into an open state allowing said moving phase to leave the chamber.

7. Apparatus according to claim 6, characterized in that said chamber (1) houses means for analyzing the components of the sample.

8. Apparatus according to any one of claims 1 to 7, characterized in that said chamber (1) is organized to receive an extractable cassette comprising said stationary phase.

9. Apparatus according to any one of claims 1 to 8, characterized in that said pressurization means comprise a flexible film (8) housed in register with the top face (5) of the stationary phase (2), and application means suitable for pressing said film (8) and said stationary phase against each other at an external pressure of selected magnitude, said film (8) having a leakproof opening (9) for enabling the dispenser means (10) to feed the stationary phase (2).

10. Apparatus according to claim 9, characterized in that said application means comprise a pump coupled to a tank (27) of external pressurization fluid and suitable for feeding an upstream portion (15) of a circuit that opens out beneath the stationary phase (2), and in that said chamber (1) has a second leakproof outlet (21) organized to receive the external pressurization fluid in order to feed a downstream portion (20) of the circuit connected to said tank (27).

11. Apparatus according to claim 10, characterized in that said external pressurization fluid pump (27) and said moving phase feed means are placed in a fluid feed unit (23) controlled by said control module (25).

12. Apparatus according to any one of claims 1 to 11, characterized in that said stationary phase (2) is provided with said sample to be treated prior to being introduced into said chamber (1).

13. Apparatus according to any one of claims 1 to 11, characterized in that said chamber (1) has a second inlet via which the sample is conveyed to the first location (6) of said stationary phase (2).

14. Apparatus according to any one of claims 1 to 13, characterized in that said first and second locations (6, 7) coincide, at least in part.

15. Apparatus according to claim 14, characterized in that said feed means are organized to feed said first inlet with the stationary and moving phases.

16. Apparatus according to any one of claims 13 to 15, characterized in that the control module (25) is organized, prior to delivering the sample, firstly to cause said valve (31) to take up a state in which it prevents the moving phase from being removed from the chamber, and secondly to cause the feed means to supply the stationary phase with a selected volume of the moving phase.

17. Apparatus according to claim 16, characterized in that said volume is selected in such a manner as to be substantially equal to the volume required to ensure that the measured pressure is substantially equal to the threshold pressure.

18. Apparatus according to any one of claims 3 to 17, characterized in that said measurement means (29; 30) comprise a first sensor (29) suitable for measuring the pressure of the moving phase upstream from said first inlet (13), and a second sensor (30) suitable for measuring the pressure of the moving phase downstream from said first outlet (18), and in that said control module (25) is organized to control said feed means and said valve (31) as a function of a first comparison between the pressure measured upstream from the chamber and a first threshold pressure, and of a second comparison between the pressure measured downstream from the chamber and a second threshold pressure.

19. A method of treating a sample by pressurized planar separation, the method being characterized in that it comprises the following steps:
a) placing at least one stationary phase in a chamber, the stationary phase being suitable for receiving at least one sample for treatment at at least one selected first location;
b) feeding the stationary phase at at least one second selected location with a moving phase, while applying an external pressure of selected magnitude to a top face of said stationary phase and preventing said moving phase to leave the stationary phase;
c) measuring the pressure of the moving phase upstream and/or downstream from the chamber; and
d) comparing said measured pressure with a threshold pressure depending on the selected external pressure and, when the measured pressure is greater than or equal to said threshold pressure, reducing the pressure of the moving phase so that this pressure remains lower than or equal to the threshold pressure.

20. A method according to claim 19, characterized in that in step d) the feed of moving phase is interrupted definitively when the measured pressure becomes greater than or equal to the threshold pressure, after which the moving phase introduced in the stationary phase is placed a the ambient pressure and the external pressure is released.

21. A method according to claim 19, characterized in that in step d) when the measured pressure becomes larger than or equal to the threshold pressure, the moving phase is allowed to leave the chamber at a selected non-zero flow rate and the feed of moving phase to the stationary phase is maintained.

22. A method according to claim 19, characterized in that in step d) the moving phase is fed by pressurization and/or by an electric field.
